(19) United States
(12) Patent Application Publication
(10) Pub. No.: US 2026/0112621 A1
(43) Pub. Date: Apr. 23, 2026

(54) POSITIVE ELECTRODE ACTIVE MATERIAL FOR LITHIUM-ION SECONDARY BATTERY

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/290,787

(22) Filed: Aug. 5, 2025

(30) Foreign Application Priority Data
Oct. 22, 2024 (JP) 2024-186005

(51) Int. Cl. H01M 4/525; H01M 4/505; H01M 10/0525; H01M 4/02

(52) U.S. Cl. CPC H01M 4/525; H01M 4/505; H01M 10/0525; H01M 2004/021; H01M 2004/028

(57) ABSTRACT

A positive electrode active material for a lithium-ion secondary battery contains monocrystalline particles. The monocrystalline particle includes a first pyramidal portion and a second pyramidal portion. The first pyramidal portion protrudes in a first direction. The first pyramidal portion has a first outer diameter. The first outer diameter indicates a diameter of a minimum circumscribed circle with respect to the first pyramidal portion. The second pyramidal portion protrudes in a second direction. The second pyramidal portion has a second outer diameter. The second outer diameter indicates a diameter of a minimum circumscribed circle with respect to the second pyramidal portion. The first outer diameter is larger than the second outer diameter. An angle between the first direction and the second direction is greater than 0° and 45° or less.

### CROSS-REFERENCE TO RELATED APPLICATION

This application claims priority to Japanese Patent Application No. 2024-186005 filed on October 22, 2024. The disclosure of the above-identified application, including the specification, drawings, and claims, is incorporated by reference herein in its entirety.

### BACKGROUND

### 1. Technical Field

The present disclosure relates to a positive electrode active material for a lithium-ion secondary battery.

### 2. Description of Related Art

Japanese Unexamined Patent Application Publication No. 2023-036570 (JP 2023-036570 A) discloses a ternary positive electrode material.

### SUMMARY

In general, a positive electrode active material for a lithium-ion secondary battery (hereinafter, may be abbreviated as "positive electrode active material") provides secondary particles. The secondary particles are aggregates of a plurality of primary particles. The primary particles repeat expansion and contraction through repetition of charging and discharging reactions. A gap may be generated between the primary particles, by a change in volumes of the primary particles. Conductive paths between the primary particles and conductive paths between the secondary particles may be cut by the generation of the gap. Therefore, there is a possibility that a desired cycle characteristic cannot be obtained.

An object of the present disclosure is to improve a cycle characteristic.

A positive electrode active material for a lithium-ion secondary battery includes a monocrystalline particle.

The monocrystalline particle includes a first pyramidal portion and a second pyramidal portion.

The first pyramidal portion protrudes in a first direction.

The first pyramidal portion has a first outer diameter.

The first outer diameter represents a diameter of a minimum circumscribed circle of the first pyramidal portion.

The second pyramidal portion protrudes in a second direction.

The second pyramidal portion has a second outer diameter.

The second outer diameter represents a diameter of a minimum circumscribed circle of the second pyramidal portion.

The first outer diameter is larger than the second outer diameter. An angle between the first direction and the second direction is larger than 0° and not larger than 45°.

In the related art, a monocrystalline particle having an octahedral shape is known. In an octahedron (bipyramid), two pyramidal portions (pyramids) share a bottom surface and protrude in directions opposite to each other. That is, it is considered that an angle between the directions in which the two pyramidal portions protrude is about 180°.

The monocrystalline particle in the present disclosure has a novel structure. That is, the sizes of the two pyramidal portions are different from each other, and the angle between the two pyramidal portions is not larger than 45°. According to the new findings of the present disclosure, as the monocrystalline particles have the same structure, the volume change of the monocrystalline particles can be reduced. Since conductive paths between the primary particles and conductive paths between the secondary particles are less likely to be cut, the improvement in the cycle characteristic is expected.

The positive electrode active material for a lithium-ion secondary battery according to the above description may include, for example, the following configuration.

A relationship of "0.010 < D_{b}/Dₐ ≤ 0.750" is satisfied.

The "Dₐ" represents the first outer diameter.

The "D_{b}" represents the second outer diameter.

Regarding the sizes of the first pyramidal portion and the second pyramidal portion, the relationship of "0.010 < D_{b}/Dₐ ≤ 0.750" is satisfied, whereby the improvement in the cycle characteristic is expected.

The positive electrode active material for a lithium-ion secondary battery according to the above description may include, for example, the following configuration.

A bottom surface of the second pyramidal portion is fused to a side surface of the first pyramidal portion.

The positive electrode active material for a lithium-ion secondary battery according to the above description may include, for example, the following configuration.

The monocrystalline particle further includes a third pyramidal portion. The third pyramidal portion protrudes in a third direction.

The first direction, the second direction, and the third direction are different from each other.

A bottom surface of the third pyramidal portion is fused to a bottom surface of the first pyramidal portion.

The positive electrode active material for a lithium-ion secondary battery according to the above description may include, for example, the following configuration.

The positive electrode active material has a crystal structure belonging to a space group R-3m.

Hereinafter, an embodiment of the present disclosure (hereinafter, may be abbreviated as "the present embodiment") and an example of the present disclosure (hereinafter, may be abbreviated as "the present example") will be described. Meanwhile, the present embodiment and the present example do not limit the technical scope of the present disclosure. The present embodiment and the present example are illustrative in all respects. The present embodiment and the present example are non-restrictive. The technical scope of the present disclosure includes all changes within the meaning and the scope that are equivalent to the description of CLAIMS. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a first conceptual diagram showing monocrystalline particles in the present embodiment;

FIG. 2 is a second conceptual diagram showing the monocrystalline particles in the present embodiment; and

FIG. 3 is a table showing the experimental results.

### DETAILED DESCRIPTION OF EMBODIMENTS

### Terms and Phrases

Geometrical terms should not be interpreted in a strict sense. Examples of the geometrical terms include "parallel", "perpendicular", and "orthogonal". For example, the direction, the angle, and the distance may be relatively displaced within a range in which substantially the same or similar functions can be obtained. The geometrical term may include, for example, a tolerance and an error in design, operation, and manufacturing. The dimensional relationships in each of the drawings sometimes do not agree with the actual dimensional relationships. In order to facilitate understanding of the reader, the dimensional relationship in each of the drawings may be changed. For example, the length, the width, and the thickness may be changed. In some cases, a part of the configuration may be omitted.

The "monocrystalline particle" refers to a particle that cannot be further divided into smaller units by a dispersing machine or a pulverizer. The monocrystalline particles may be referred to as primary particles, aggregates, or the like. The aggregate of the monocrystalline particles may be referred to as secondary particles, aggregates, and the like.

The space group to which the crystal structure belongs can be identified by measuring the powder X-ray diffraction (XRD).

The shape of the monocrystalline particles and the shape of each of the pyramidal portions can be specified by at least one of a three-dimensional SEM (Scanning Electron Microscope) observation method and a cross section SEM observation method. A direction in which the pyramidal portion protrudes is a direction from a center of a bottom surface of the pyramidal portion toward a vertex of the pyramidal portion. In the case of the cross-sectional image, the direction from the midpoint of the base of the triangle to the vertex of the triangle is indicated. An angle between two directions (two straight lines) indicates an obtuse angle.

The specification (fitting) of the minimum circumscribed circle of each of the pyramidal portions can be executed by image analysis software. For example, "Image J" may be used. The diameter of the minimum circumscribed circle is regarded as the outer diameter of the pyramidal portion.

### Positive Electrode Active Material

The positive electrode active material is for a lithium-ion secondary battery. A lithium-ion secondary battery (hereinafter, may be abbreviated as "battery") may be a liquid battery or an all-solid battery. The battery may have any structure. The battery may have, for example, a wound or stacked power generation element. The battery may have, for example, a unipolar structure or a bipolar structure.

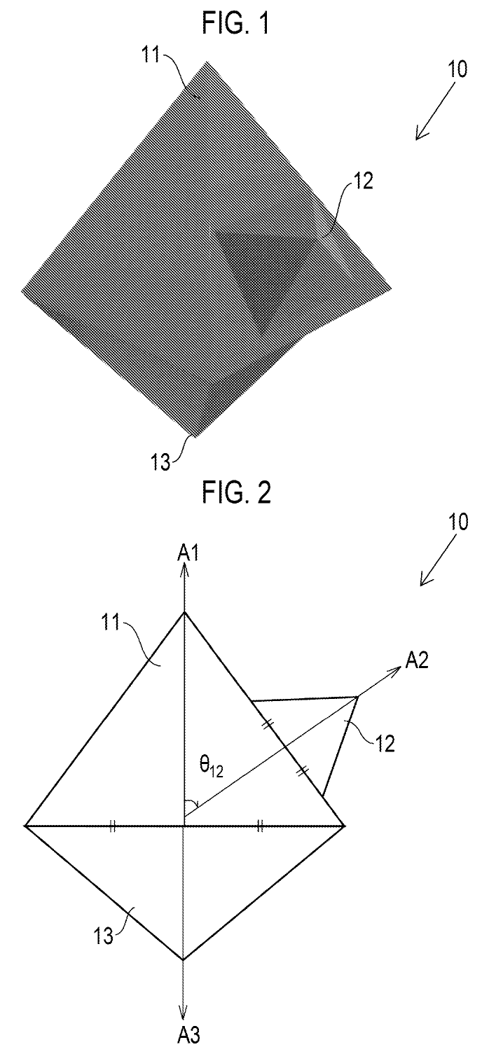

FIG. 1 is a first conceptual diagram showing a monocrystalline particle in the present embodiment. FIG. 2 is a second conceptual diagram showing the monocrystalline particles in the present embodiment. A second conceptual diagram shows a cross section of the monocrystalline particle 10 shown in FIG. 1.

The monocrystalline particle 10 includes a first pyramidal portion 11 and a second pyramidal portion 12. An outer diameter (first outer diameter "Dₐ") of the first pyramidal portion 11 is larger than an outer diameter (second outer diameter "D_{b}") of the second pyramidal portion 12. That is, the relationship of "D_{b}/Dₐ < 1" is satisfied. The outer diameter ratio "D_{b}/Dₐ" may be, for example, 0.900 or less, 0.800 or less, 0.750 or less, 0.500 or less, 0.250 or less, 0.100 or less, 0.075 or less, 0.050 or less, or 0.025 or less. The outer diameter ratio "D_{b}/Dₐ" may be, for example, 0.010 or more, more than 0.010, 0.013 or more, 0.015 or more, 0.020 or more, 0.025 or more, 0.050 or more, 0.075 or more, 0.100 or more, 0.150 or more, 0.300 or more, 0.450 or more, or 0.600 or more. For example, the relationship of "0.010 < D_{b}/Dₐ ≤ 0.750" may be satisfied. By satisfying the relationship, improvement of the cycle characteristics is expected.

The first pyramidal portion 11 protrudes in a first direction A1. The second pyramidal portion 12 protrudes in a second direction A2. An angle θ₁₂ between the first direction A1 and the second direction A2 is greater than 0° and equal to or smaller than 45°. By satisfying the relationship of "0° < θ₁₂ ≤ 45°", the improvement of the cycle characteristics is expected. The angle θ₁₂ may be, for example, 40° or less, 39° or less, 38° or less, 36° or less, 35° or less, 34° or less, 33° or less, 32° or less, 31° or less, or 30° or less. The angle θ₁₂ may be, for example, 5° or more, 10° or more, 15° or more, 20° or more, or 25° or more.

The second pyramidal portion 12 may be directly connected to the first pyramidal portion 11. For example, the bottom surface of the second pyramidal portion 12 may be fused to the side surface of the first pyramidal portion 11. In the fusion portion, the boundary between the two pyramidal portions may be recognizable, or the boundary between the two pyramidal portions may not be recognizable.

The monocrystalline particle 10 may include three or more pyramidal portions. The number of pyramidal portions included in the monocrystalline particles 10 may be, for example, four or more, six or more, eight or more, or 10 or more. The number of pyramidal portions included in the monocrystalline particles 10 may be, for example, nine or less, seven or less, or five or less. Each of the pyramidal portions may be independently, for example, a triangular cone shape, a quadrangular cone shape, a pentagonal cone shape, a hexagonal cone shape, or an octagonal cone shape.

The monocrystalline particle 10 may further include, for example, the third pyramidal portion 13. The third pyramidal portion 13 protrudes in a third direction A3. The first direction A1, the second direction A2, and the third direction A3 may be different from each other. The angle θ₁₃ between the first direction A1 and the third direction A3 may be, for example, more than 45°, more than 60°, more than 75°, more than 90°, more than 105°, more than 120°, more than 135°, more than 150°, or more than 165°. The angle θ₁₃ may be, for example, 180° or less, 165° or less, 150° or less, 135° or less, 120° or less, or 105° or less.

In a case where the monocrystalline particle 10 includes three or more pyramidal portions, for example, the first pyramidal portion 11 may be a pyramidal portion (main pyramidal portion) having the largest size. For example, a relationship of "D_{b} < D_{c} ≤ Dₐ" or "D_{c} ≤ D_{b}< Dₐ" may be satisfied. "D_{c}" represents an outer diameter (third outer diameter) of the third pyramidal portion 13.

The third pyramidal portion 13 may be directly connected to the first pyramidal portion 11. The connection surface between the third pyramidal portion 13 and the first pyramidal portion 11 and the connection surface between the second pyramidal portion 12 and the first pyramidal portion 11 may be the same or may be different. For example, the bottom surface of the third pyramidal portion 13 may be fused to the bottom surface of the first pyramidal portion 11.

The monocrystalline particle 10 may be present alone. The monocrystalline particles 10 may provide secondary particles. The number of monocrystalline particles 10 included in the secondary particle may be, for example, two or more, four or more, six or more, or eight or more. The number of monocrystalline particles 10 included in the secondary particle may be, for example, 9 or less, 7 or less, 5 or less, or 3 or less.

The positive electrode active material (powder) may be provided by monocrystalline particles 10. The positive electrode active material may further include monocrystalline particles, secondary particles, or the like having other shapes as long as the monocrystalline particles 10 are included. The number proportion of the monocrystalline particles 10 in the positive electrode active material (powder) may be, for example, 5% or more, 10% or more, 25% or more, 50% or more, or 75% or more.

The positive electrode active material may have any chemical composition. The positive electrode active material may have, for example, a crystal structure belonging to the space group R-3m. The positive electrode active material may include, for example, at least one selected from the group consisting of lithium nickel composite oxide, lithium nickel cobalt manganese composite oxide, and lithium nickel cobalt aluminum composite oxide. The positive electrode active material may have a composition represented by, for example, a general formula "LiₓNiₐCo_{b}Mn_{c}O_{y}". In the general formula, for example, the relationship of "0.1 ≤ x ≤ 1.5", "0.5 ≤ a ≤ 1.0", "0 ≤ b ≤ 0.3", "0 ≤ c ≤ 0.3", "a + b + c = 1.0", and "1.5 ≤ y ≤ 2.1" may be satisfied. In the general formula, for example, a relationship of "0.9 ≤ x ≤ 1.1", "0.7 ≤ a ≤ 0.9", "0.05 ≤ b ≤ 0.15", or "0.05 ≤ c ≤ 0.15" may be satisfied. Any dopant may be added to the positive electrode active material.

### Sample Preparation

### No. 1

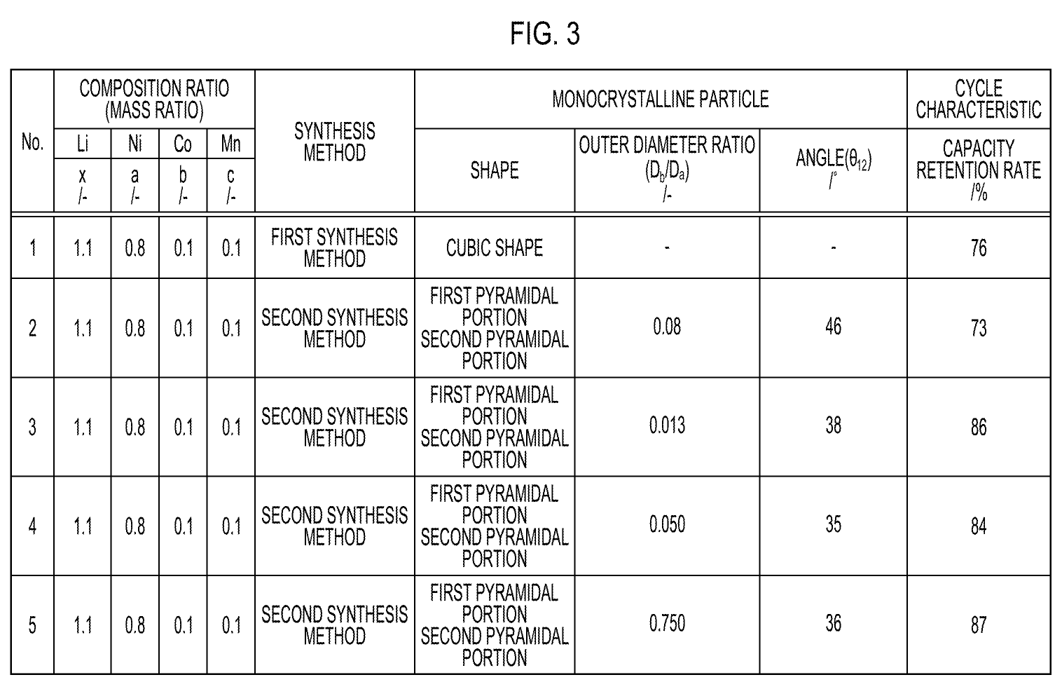

FIG. 3 is a table showing the experimental results. The raw material solution was provided by dissolving NiSO₄, CoSO₄, and MnSO₄ in ion-exchange water. In the raw material solution, the molar ratio of Ni, Co, and Mn was "Ni/Co/Mn = 8/1/1". The solute concentration in the raw material solution was 30% (mass fraction).

Ammonium hydroxide was charged into the reaction vessel. The reaction vessel was substituted with nitrogen while the ammonia water was stirred with a stirrer. Further, NaOH was put into the reaction vessel, whereby an alkaline reaction solution was provided.

The raw material solution and the aqueous ammonia were dropped into the reaction solution such that the reaction solution maintained a pH in a certain range, whereby a precipitate (metal hydroxide) was provided. The reaction solution was filtered to recover the metal hydroxide. The metal hydroxide was dispersed in ion-exchanged water to provide a dispersion liquid. The dispersion liquid was sufficiently stirred with a spatula. That is, the metal hydroxide was washed with water. After washing, the dispersion liquid was filtered to recover the metal hydroxide. The metal hydroxide was dried at 120°C for 16 hours to provide a dry solid.

In a mortar, a mixture was provided by mixing a dry matter (metal hydroxide) and a lithium compound (LiOH, Li₂CO₃) with a pestle. The ratio of the mass of Li to the mass of the metal hydroxide was 1.1.

In the muffle furnace, the mixture was heat-treated to synthesize the positive electrode active material. The conditions of the heat treatment (firing) were as follows. After the heat treatment, the particle size of the positive electrode active material was adjusted by a jet mill.

Atmosphere: Oxygen atmosphere

Temperature: 700°C to 1,100°C

Time: 10 hours

### No. 2

In the same manner as in No. 1, a dry matter (metal hydroxide) was prepared by the coprecipitation method. In a mortar, a first mixture was provided by mixing a dry matter (metal hydroxide), a lithium compound (LiOH, Li₂CO₃), and a flux (Li₂SO₄, LiNO₃, LiCH₃COOH) with a pestle. The ratio of the mass of Li to the mass of the metal hydroxide was 1.1.

In the muffle furnace, the first mixture was heat-treated for 5 hours at the melting point of the flux under an oxygen atmosphere, whereby a fired product was provided.

In the mortar, the first material was provided by pulverizing the fired material with the pestle for 10 minutes.

In the jet mill, the pulverization of the fired material provided the second material.

The second mixture was provided by mixing the first material and the second material. In the muffle furnace, the second mixture was heat-treated to synthesize the positive electrode active material. The conditions of the heat treatment (main firing) were as follows. After the heat treatment, the particle size of the positive electrode active material was adjusted by a jet mill.

Atmosphere: Oxygen atmosphere

Temperature: 700°C to 1,100°C

Time: 10 hours

### No. 3 to No. 5

The positive electrode active material was manufactured in the same manner as in No. 2, except that the supply rate of the calcined material in the jet mill and the pressure of the compressed fluid were changed, whereby the second material was provided.

### Evaluation of Cycle Characteristics

A cylindrical lithium-ion secondary battery (evaluation cell) was manufactured. The configuration of the evaluation cell is as follows.

Power generation element: wound type

Positive electrode: Positive electrode active material/AB/PVDF = 88/10/2 (mass ratio)

Negative electrode: negative electrode active material (natural graphite), CMC, SBR

Electrolyte: LiPF₆ (1 mol/L), EC/DMC/EMC = 3/4/3 (volume ratio)

The positive electrode and the negative electrode were manufactured by coating the surface of a base material (metal foil) with a slurry. As the coating device, a film applicator (with a film thickness adjusting function) manufactured by ALL GOOD Co., Ltd. was used. After the slurry was coated, the coating film was dried at 80°C for 5 minutes.

Under a room temperature environment, the charge and discharge of the evaluation cell was repeated 200 times in a voltage range of 3.0 V to 4.1 V by a constant current of 2 C. The capacity retention rate (percentage) was obtained by dividing the 200th discharge capacity by the initial discharge capacity. It is considered that the higher the capacity retention rate, the better the cycle characteristics.

### Result

When the monocrystalline particles include the first pyramidal portion and the second pyramidal portion and an angle between the protrusion directions of the first pyramidal portion and the second pyramidal portion is 45° or less, the cycle characteristics tend to be improved.

When the relationship of "0.010 < D_{b}/Dₐ ≤ 0.750" is satisfied with respect to the sizes of the first pyramidal portion and the second pyramidal portion, the cycle characteristics tend to be improved.

What is claimed is:

1. A positive electrode active material for a lithium-ion secondary battery, the positive electrode active material comprising a monocrystalline particle, wherein:
the monocrystalline particle includes a first pyramidal portion and a second pyramidal portion;
the first pyramidal portion protrudes in a first direction;
the first pyramidal portion has a first outer diameter;
the first outer diameter represents a diameter of a minimum circumscribed circle of the first pyramidal portion;
the second pyramidal portion protrudes in a second direction;
the second pyramidal portion has a second outer diameter;
the second outer diameter represents a diameter of a minimum circumscribed circle of the second pyramidal portion;
the first outer diameter is larger than the second outer diameter; and
an angle between the first direction and the second direction is larger than 0° and not larger than 45°.

2. The positive electrode active material according to claim 1, wherein:
a relationship of 0.010 < D_{b}/Dₐ≤ 0.750 is satisfied;
the Dₐ represents the first outer diameter; and
the D_{b} represents the second outer diameter.

3. The positive electrode active material according to claim 1, wherein a bottom surface of the second pyramidal portion is fused to a side surface of the first pyramidal portion.

4. The positive electrode active material according to claim 1, wherein:
the monocrystalline particle further includes a third pyramidal portion;
the third pyramidal portion protrudes in a third direction;
the first direction, the second direction, and the third direction are different from each other; and
a bottom surface of the third pyramidal portion is fused to a bottom surface of the first pyramidal portion.

5. The positive electrode active material according to claim 1, wherein the positive electrode active material has a crystal structure belonging to a space group R-3m.
